(19) United States
(12) Patent Application Publication
(10) Pub. No.: US 2014/0216852 A1
(43) Pub. Date: Aug. 7, 2014

(54) IMPACT RESISTANT ARTICLE

(71) Applicant: GM GLOBAL TECHNOLOGY OPERATIONS LLC, Detroit, MI (US)

(72) Inventors: Leonard Barry Griffiths, Fenton, MI (US); David R. Staley, Flushing, MI (US)

(73) Assignee: GM GLOBAL TECHNOLOGY OPERATIONS LLC, Detroit, MI (US)

(21) Appl. No.: 13/761,471

(22) Filed: Feb. 7, 2013

(51) Int. Cl. F01M 11/00; B32B 1/02

(52) U.S. Cl. CPC F01M 11/0004; B32B 1/02
USPC 184/106; 428/34.1

(57) ABSTRACT

An impact resistant article is disclosed. The impact resistant article includes a body, with the body including a side wall and a base wall extending from the side wall. The base wall includes an exterior surface. The impact resistant article also includes an energy absorbing member, and in certain embodiments, includes a plurality of energy absorbing members each extending along a respective central axis from the exterior surface of the base wall to a respective distal end. Each of the energy absorbing members define an elliptical cross-sectional configuration transverse to the central axis of respective energy absorbing members. In certain embodiments, the energy absorbing members are spaced from each other such that during an impact to one of the energy absorbing members, the impacted one of the energy absorbing members absorbs energy independently of the other energy absorbing members.

### TECHNICAL FIELD

The present disclosure relates to an impact resistant article.

### BACKGROUND

Generally, a vehicle has an engine block and an oil pan attached to a bottom side of the engine block which contains lubricate such as oil to lubricate various moving parts. The oil pan is exposed underneath the vehicle and is therefore susceptible to being impacted by moving objects such as stones or other debris.

### SUMMARY

The present disclosure provides an impact resistant article including a body. The body includes a side wall and a base wall extending from the side wall. The base wall includes an exterior surface facing away from the side wall. The impact resistant article also includes a plurality of energy absorbing members each extending along a respective central axis from the exterior surface of the base wall to a respective distal end. Each of the energy absorbing members define an elliptical cross-sectional configuration transverse to the central axis of respective energy absorbing members. Furthermore, the energy absorbing members are spaced from each other such that during an impact to one of the energy absorbing members, the impacted one of the energy absorbing members absorbs energy independently of the other energy absorbing members.

The present disclosure also provides an impact resistant article for a vehicle. The impact resistant article includes a body adapted to be attached to the vehicle. The body includes a side wall and a base wall extending from the side wall. The base wall includes an exterior surface facing away from the vehicle. The impact resistant article also includes an energy absorbing member extending along a central axis from the exterior surface of the base wall to a distal end to absorb energy during an impact to the energy absorbing member. The energy absorbing member includes an outer wall transverse to the exterior surface. The distal end defines a recess extending along the central axis toward the exterior surface of the base wall to present an inner wall opposing the outer wall and a bottom wall transverse to the central axis. At least one of the outer and inner walls of the energy absorbing member defines a substantially circular cross-sectional configuration perpendicular to the central axis such that the energy absorbing member absorbs and transfers energy substantially uniformly from the energy absorbing member to the base wall when impacted.

Therefore, the energy absorbing members absorb energy when struck or impacted by an object which reduces an impact directly to the body of the impact resistance article. Furthermore, the energy absorbing members are configured to absorb energy by deflecting, bending or compressing which redistributes the force of the impact by the object. In addition, the energy absorbing members are configured to spread the force of the impact over the surface area of respective energy absorbing members when impacted which can reduce disruptions to the body.

The detailed description and the drawings or Figures are supportive and descriptive of the disclosure, but the scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is a schematic perspective view of an impact resistant article attached to a component.

FIG. 2 is a schematic perspective bottom view of the impact resistant article.

FIG. 3 is a schematic broken bottom view of the impact resistant article and a plurality of energy absorbing members.

FIG. 4 is a schematic cross-sectional view of a pair of the energy absorbing members taken from lines 4-4 of FIG. 3.

### DETAILED DESCRIPTION

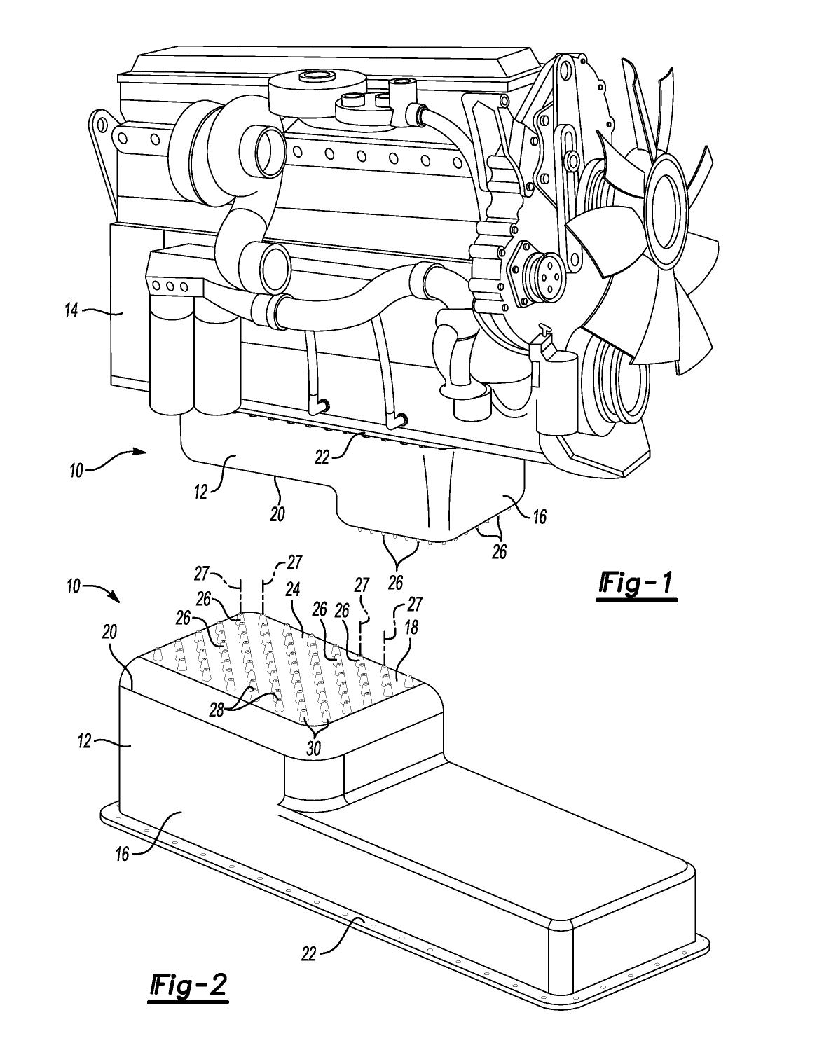

Referring to the Figures, wherein like numerals indicate like or corresponding parts throughout the several views, an impact resistant article 10 is generally shown in FIGS. 1 and 2. In certain embodiments, the impact resistant article 10 is for a vehicle. Therefore, the impact resistant article 10 can be useful for vehicles, such as automotive vehicles, etc. It is to be appreciated that the impact resistant article 10 can also be useful for non-automotive applications including, for example, farm, marine and aviation applications, etc.

Referring to FIGS. 1 and 2, the impact resistant article 10 includes a body 12. In certain embodiments, the body 12 is adapted to be attached to the vehicle. More specifically, the body 12 can be attached to a component 14 of the vehicle. For example, in automotive applications, the component 14 can be an engine block of an internal combustion engine as shown in FIG. 1. As another example, in automotive applications, the impact resistant article 10 can be further defined as an oil pan for the vehicle (see FIG. 1). Oil pans can contain a lubricant, such as oil, to lubricate various moving parts inside the engine block. It is to be appreciated that the impact resistant article 10 can be configurations other than the oil pan, such as for example, a gas tank; a fluid reservoir, such as a power steering fluid reservoir, a brake fluid reservoir and a coolant fluid reservoir; etc.

As best shown in FIG. 2, the body 12 includes a side wall 16 and a base wall 18 extending from the side wall 16. Generally, the base wall 18 extends transverse to the side wall 16. The side wall 16 can extend around an edge 20 of the base wall 18 such that the side wall 16 and the base wall 18 cooperate to define a cavity. The side wall 16 can be attached to the component 14 to secure the impact resistant article 10 to the component 14. In certain embodiments, a flange 22 can extend from the side wall 16, with the flange 22 attached to the component 14 to secure the impact resistant article 10 thereto. Therefore, the side wall 16 can be disposed between the flange 22 and the base wall 18.

Turning to FIGS. 1 and 2, the base wall 18 includes an exterior surface 24 facing away from the side wall 16. More specifically, in certain embodiments, the exterior surface 24 faces away from the vehicle. Generally, the exterior surface 24 of the base wall 18 is exposed underneath the vehicle. Therefore, the exterior surface 24 can be struck or impacted by objects such as stones, or other debris as the vehicle travels along a road, a street, etc.

As best shown in FIG. 2, in certain embodiments, the impact resistant article 10 includes an energy absorbing member 26 extending along a central axis 27 from the exterior surface 24 of the base wall 18 to a distal end 28 to absorb energy during an impact to the energy absorbing member 26. Therefore, if an object is kicked up under the vehicle, the object can strike or impact the energy absorbing member 26 which reduces direct strikes or impacts to the body 12. More specifically, striking or impacting the energy absorbing member 26 reduces direct strikes or impacts to the exterior surface 24 of the base wall 18. Furthermore, the energy absorbing member 26 is configured to absorb energy by deflecting, bending or compressing which redistributes the force of the impact by the object. Therefore, the energy absorbing member 26 is configured to spread the force of the impact over the surface area of the energy absorbing member 26 when impacted which can reduce disruptions to the body 12.

Referring to FIGS. 2-4, generally, the energy absorbing member 26 includes an outer wall 30 transverse to the exterior surface 24. Specifically, the outer wall 30 is disposed between the exterior surface 24 of the base wall 18 and the distal end 28 of the energy absorbing member 26. The distal end 28 defines a recess 32 extending along the central axis 27 toward the exterior surface 24 of the base wall 18 to present an inner wall 34 opposing the outer wall 30 and a bottom wall 36 transverse to the central axis 27. Furthermore, the bottom wall 36 is transverse to the outer and inner walls 30, 34. In certain embodiments, the bottom wall 36 is perpendicular to the central axis 27.

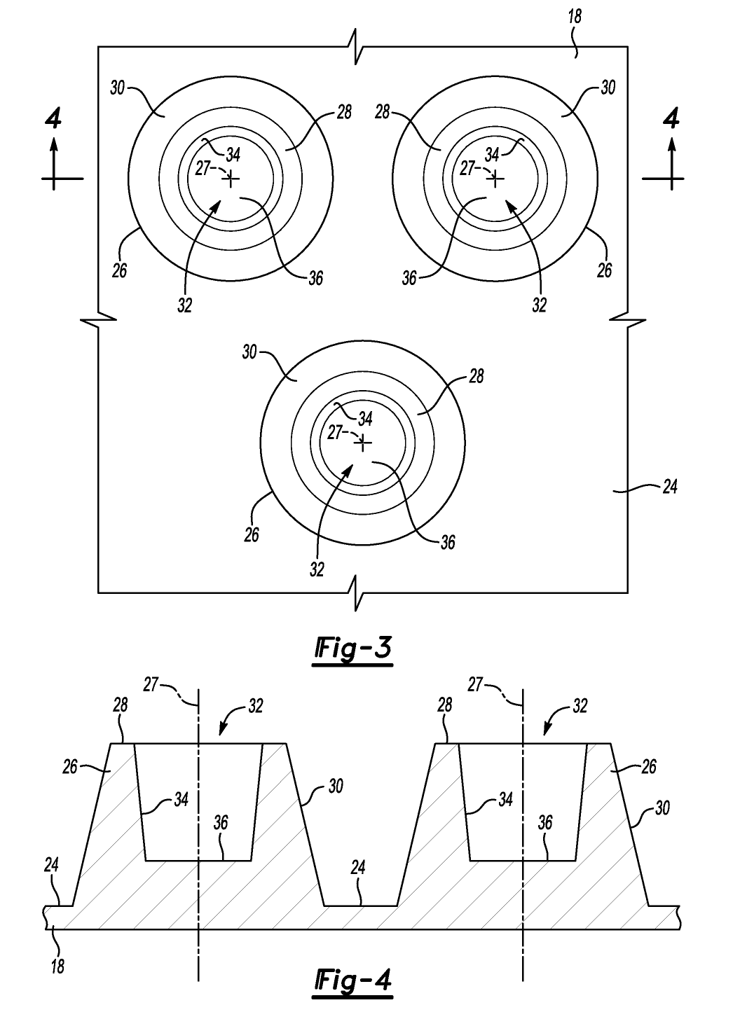

Generally, the energy absorbing member 26 defines an elliptical cross-sectional configuration (see FIGS. 2 and 3) transverse to the central axis 27. More specifically, at least one of the outer and inner walls 30, 34 of the energy absorbing member 26 can define the elliptical cross-sectional configuration. In one embodiment, the outer wall 30 of the energy absorbing member 26 can further define the elliptical cross-sectional configuration. In another embodiment, the inner wall 34 of the energy absorbing member 26 can further define the elliptical cross-sectional configuration. In yet another embodiment, the outer and inner walls 30, 34 of the energy absorbing member 26 both can define the elliptical cross-sectional configuration.

In certain embodiments, the elliptical cross-sectional configuration is further defined as a substantially circular cross-sectional configuration perpendicular to the central axis 27. Therefore, at least one of the outer and inner walls 30, 34 of the energy absorbing member 26 can define the substantially circular cross-sectional configuration perpendicular to the central axis 27 such that the energy absorbing member 26 absorbs and transfers energy substantially uniformly from the energy absorbing member 26 to the base wall 18 when impacted. In one embodiment, the outer wall 30 of the energy absorbing member 26 can further define the substantially circular cross-sectional configuration. The outer wall 30 can define the substantially circular cross-sectional configuration such that the outer wall 30 absorbs and transfers energy substantially uniformly from the energy absorbing member 26 to the base wall 18 when impacted. In another embodiment, the inner wall 34 of the energy absorbing member 26 can further define the substantially circular cross-sectional configuration. In yet another embodiment, the outer and inner walls 30, 34 of the energy absorbing member 26 each can further define the substantially circular cross-sectional configuration.

Therefore, when the energy absorbing member 26 is being impacted, the elliptical cross-sectional configuration yields substantially uniformly to absorb the impact and transfer energy substantially uniformly to the base wall 18 as compared to walls having corners, ridges, ribs, etc. extending outwardly therefrom which create areas less compliant. For example, corners, ridges, ribs, etc. create high stress areas or regions when impacted. Therefore, the elliptical cross-sectional configuration provides a substantially uniformly compliant energy absorbing member 26 when impacted which transfers energy substantially uniformly to the base wall 18 when the energy absorbing member 26 is impacted. The energy absorbing member 26 is configured to distribute energy substantially evenly around the energy absorbing member 26 when impacted, and thus distribute energy substantially evenly to the base wall 18 which eliminates any high stress areas or regions. For example, disruptions to the body 12 can be reduced by distributing energy from the impact substantially evenly around the energy absorbing member 26 and to the base wall 18. It is to be appreciated that the energy transferred to the base wall 18 can vary slightly in different regions around the energy absorbing member 26 due to the continuous curvature of the energy absorbing member 26, however, as suggested above, having the energy absorbing member 26 curve allows for energy to be distributed substantially evenly, and thus eliminates any high stress areas or regions.

Furthermore, the recess 32 of the energy absorbing member 26 allows the outer and inner walls 30, 34 of the energy absorbing member 26 to deflect when being impacted. Having the outer wall 30, and more specifically, the outer and inner walls 30, 34, define the elliptical cross-sectional configuration provides the energy absorbing member 26 to comply substantially uniformly to absorb the impact and spreads the force of the impact over the surface area of the energy absorbing member 26 which can reduce disruptions to the body 12.

As shown in FIG. 4, optionally, in certain embodiments, the outer wall 30 of the energy absorbing member 26 can taper inwardly toward the inner wall 34 from the exterior surface 24 of the base wall 18 to the distal end 28. Therefore, the outer wall 30 defines a first diameter adjacent to the exterior surface 24 of the base wall 18 and the outer wall 30 defines a second diameter adjacent to the distal end 28. Generally, the second diameter of the outer wall 30 is less than the first diameter of the outer wall 30. Simply stated, the diameter of the outer wall 30 decreases as the outer wall 30 extends toward the distal end 28.

Continuing with FIG. 4, optionally, in certain embodiments, the inner wall 34 of the energy absorbing member 26 can taper outwardly toward the outer wall 30 from the bottom wall 36 to the distal end 28. Therefore, the inner wall 34 defines a first diameter adjacent to the bottom wall 36 and the inner wall 34 defines a second diameter adjacent to the distal end 28. Generally, the first diameter of the inner wall 34 is less than the second diameter of the inner wall 34. Simply stated, the diameter of the inner wall 34 increases as the inner wall 34 extends toward the distal end 28.

As best shown in FIGS. 2 and 3, in certain embodiments, the impact resistant article 10 includes a plurality of energy absorbing members 26 each extending along a respective central axis 27 from the exterior surface 24 of the base wall 18 to a respective distal end 28. In other words, the energy absorbing member 26 can be further defined as the plurality of energy absorbing members 26. The details of the single energy absorbing member 26 as discussed above also applies to the configuration of each of the plurality of energy absorbing members 26, and therefore only some of the details of the plurality of energy absorbing members 26 are discussed below. It is to be appreciated that the location that the energy absorbing members 26 extend from in the Figures is for illustrative purposes only and the energy absorbing members 26 can extend from the body 12 in other locations.

Continuing with FIGS. 2 and 3, generally, each of the energy absorbing members 26 define the elliptical cross-sectional configuration transverse to the central axis 27 of respective energy absorbing members 26. The energy absorbing members 26 are spaced from each other such that during the impact to one of the energy absorbing members 26, the impacted one of the energy absorbing members 26 absorbs energy independently of the other energy absorbing members 26. In other words, the energy absorbing members 26 do not intersect or touch each other (see FIGS. 3 and 4). Therefore, generally, the energy absorbing members 26 adjacent to the impacted energy absorbing member 26 are not deflected, bent or compressed by the impact. If more than one of the energy absorbing members 26 are impacted, each of the energy absorbing members 26 absorb energy independently of the other impacted energy absorbing members 26.

The energy absorbing members 26 can each include the outer wall 30 and the inner wall 34 opposing the outer wall 30 of respective energy absorbing members 26. Generally, as discussed above, the outer wall 30 can be transverse to exterior surface 24 of the base wall 18. At least one of the outer and inner walls 30, 34 of each of the energy absorbing members 26 can further define the elliptical cross-sectional configuration. In one embodiment, the outer wall 30 of each of the energy absorbing members 26 can further define the elliptical cross-sectional configuration. In another embodiment, the inner wall 34 of each of the energy absorbing members 26 can further define the elliptical cross-sectional configuration. In yet another embodiment, both the outer and inner walls 30, 34 of each of the energy absorbing members 26 can define the elliptical cross-sectional configuration.

In certain embodiments, the elliptical cross-sectional configuration is further defined as a substantially circular cross-sectional configuration perpendicular to the central axis 27 of respective energy absorbing members 26. Therefore, in yet another embodiment, the outer wall 30 of each of the energy absorbing members 26 can further define the substantially circular cross-sectional configuration and the inner wall 34 of each of the energy absorbing members 26 can further define the substantially circular cross-sectional configuration such that the outer and inner walls 30, 34 of respective energy absorbing members 26 cooperate to generally define a ring (see FIGS. 3 and 4). Simply stated, in this embodiment, both the outer and inner walls 30, 34 of each of the energy absorbing members 26 define the substantially circular cross-sectional configuration to present the ring.

When one or more of the energy absorbing members 26 are impacted, the impacted ring is deflected, bent or compressed to redistribute the force of the impact by the object. Therefore, the energy absorbing members 26 are configured to spread the force of the impact over the surface area of respective energy absorbing members 26 when impacted which can reduce disruptions to the body 12. In addition, the outer wall 30 of each of the energy absorbing members 26 can further define the substantially circular cross-sectional configuration such that the outer wall 30 of the impacted one of the energy absorbing members 26 absorbs and transfers energy substantially uniformly from the impacted one of the energy absorbing members 26 to the base wall 18. When one or more of the energy absorbing members 26 are impacted, the elliptical cross-sectional configuration yields substantially uniformly to absorb the impact and transfer energy substantially uniformly to the base wall 18 as compared to walls having corners, ridges, ribs, etc. extending outwardly therefrom which create areas less compliant. For example, corners, ridges, ribs, etc. create high stress areas or regions when impacted. Therefore, the elliptical cross-sectional configuration provides for substantially uniformly compliant energy absorbing members 26 when impacted which transfers energy substantially uniformly to the base wall 18 when the energy absorbing member 26 is impacted. The energy absorbing members 26 are configured to distribute energy substantially evenly around the impacted one of the energy absorbing members 26, and thus distribute energy substantially evenly to the base wall 18 which eliminates any high stress areas or regions. For example, disruptions to the body 12 are reduced by distributing energy from the impact substantially evenly around the impacted one of the energy absorbing members 26 and to the base wall 18. As discussed above, it is to be appreciated that the energy transferred to the base wall 18 can vary slightly in different regions around the impacted one of the energy absorbing members 26 due to the continuous curvature of the energy absorbing members 26, however, as suggested above, having the energy absorbing members 26 curve allows for energy to be distributed substantially evenly, and thus eliminates any high stress areas or regions.

Furthermore, the stiffness of each of the energy absorbing members 26 can be changed by changing the thickness of each of the energy absorbing members 26 which can change the amount of energy being absorbed in each of the energy absorbing members 26. For example, increasing the thickness of the ring of each of the energy absorbing members 26 can increase the stiffness and decreasing the thickness of the ring of each of the energy absorbing members 26 can decrease the stiffness. Therefore, the amount of deflection, bending or compression can correspondingly change with the thickness of each of the energy absorbing members 26.

Turning to FIG. 4, the distal end 28 of each of the energy absorbing members 26 can define the recess 32 extending along the central axis 27 of respective energy absorbing members 26 toward the exterior surface 24 of the base wall 18 to present the inner wall 34. More specifically, the recess 32 extends along the central axis 27 toward the exterior surface 24 of the base wall 18 to present the inner wall 34 opposing the outer wall 30 of respective energy absorbing members 26 and the bottom wall 36 transverse to the central axis 27 of respective energy absorbing members 26. In certain embodiments, the bottom wall 36 of each of the energy absorbing members 26 can be perpendicular to the central axis 27 of respective energy absorbing members 26. The recess 32 extends toward the exterior surface 24 of the base wall 18 to present the inner wall 34 such that the recess 32 allows the outer and inner walls 30, 34 of respective energy absorbing members 26 to deflect when being impacted. Therefore, the recess 32 of each of the energy absorbing members 26 further define the ring of respective energy absorbing members 26 and the recess 32 of each of the energy absorbing members 26 further define the substantially circular cross-sectional configuration.

Optionally, the outer wall 30 of each of the energy absorbing members 26 can taper inwardly from the exterior surface 24 of the base wall 18 to the distal end 28 of respective energy absorbing members 26. More specifically, the outer wall 30 of each of the energy absorbing members 26 can taper inwardly toward the inner wall 34 of respective energy absorbing members 26 from the exterior surface 24 of the base wall 18 to the distal end 28 of respective energy absorbing members 26. Furthermore, optionally, the inner wall 34 of each of the energy absorbing members 26 can taper outwardly from the bottom wall 36 to the distal end 28 of respective energy absorbing members 26. More specifically, the inner wall 34 of each of the energy absorbing members 26 can taper outwardly toward the outer wall 30 of respective energy absorbing members 26 from the bottom wall 36 to the distal end 28 of respective energy absorbing members 26. It is to be appreciated that the energy absorbing members 26 can taper in any suitable direction.

The energy absorbing members 26 and the body 12 can be formed of a composite material molded together as one-piece. For example, the oil pan with the energy absorbing members 26 can be formed of the composite material. The composite material can be a glass-reinforced polyamide, a glass-reinforced nylon, or any other suitable composite material. Therefore, the energy absorbing members 26 and the body 12 can be integrally formed to each other. In other words, the oil pan and the energy absorbing members 26 can be integrally formed to each other.

As mentioned above, the body 12 and the energy absorbing members 26 can be molded. A die can be utilized to mold the body 12 and the energy absorbing members 26 together as one-piece. The die can be formed of a metal material, such as for example, steel or any other suitable material. In one embodiment, the die can be machined to form the pattern for the energy absorbing members 26. For example, a milling machine, such as an end mill, a slot mill, etc. can be utilized to form the pattern for the energy absorbing members 26 in the die which can reduce tooling costs. In another embodiment, the die can be burnt by electrodes to form the pattern for the energy absorbing members 26. It is to be appreciated that the outer and inner walls 30, 34 of the energy absorbing members 26 can be tapered to allow for draft in the molding process.

While the best modes for carrying out the disclosure have been described in detail, those familiar with the art to which this disclosure relates will recognize various alternative designs and embodiments for practicing the disclosure within the scope of the appended claims.

1. An impact resistant article comprising:
a body including a side wall and a base wall extending from the side wall, with the base wall including an exterior surface facing away from the side wall; and
a plurality of energy absorbing members each extending along a respective central axis from the exterior surface of the base wall to a respective distal end and each of the energy absorbing members defining an elliptical cross-sectional configuration transverse to the central axis of respective energy absorbing members, with the energy absorbing members spaced from each other such that during an impact to one of the energy absorbing members, the impacted one of the energy absorbing members absorbs energy independently of the other energy absorbing members.

2. An article as set forth in claim 1 wherein the energy absorbing members each include an outer wall and an inner wall opposing the outer wall of respective energy absorbing members, with at least one of the outer and inner walls of each of the energy absorbing members further defining the elliptical cross-sectional configuration.

3. An article as set forth in claim 2 wherein the outer wall of each of the energy absorbing members further define the elliptical cross-sectional configuration.

4. An article as set forth in claim 2 wherein the inner wall of each of the energy absorbing members further define the elliptical cross-sectional configuration.

5. An article as set forth in claim 2 wherein the elliptical cross-sectional configuration is further defined as a substantially circular cross-sectional configuration perpendicular to the central axis of respective energy absorbing members, with the outer wall of each of the energy absorbing members further defining the substantially circular cross-sectional configuration and the inner wall of each of the energy absorbing members further defining the substantially circular cross-sectional configuration such that the outer and inner walls of respective energy absorbing members cooperate to generally define a ring.

6. An article as set forth in claim 2 wherein the distal end of each of the energy absorbing members define a recess extending along the central axis of respective energy absorbing members toward the exterior surface of the base wall to present the inner wall such that the recess allows the outer and inner walls of respective energy absorbing members to deflect when being impacted.

7. An article as set forth in claim 2 wherein the outer wall of each of the energy absorbing members taper inwardly toward the inner wall of respective energy absorbing members from the exterior surface of the base wall to the distal end of respective energy absorbing members and wherein the inner wall of each of the energy absorbing members taper outwardly toward the outer wall of respective energy absorbing members from the bottom wall to the distal end of respective energy absorbing members.

8. An article as set forth in claim 2 wherein the elliptical cross-sectional configuration is further defined as a substantially circular cross-sectional configuration perpendicular to the central axis of respective energy absorbing members, with the outer wall of each of the energy absorbing members further defining the substantially circular cross-sectional configuration such that the outer wall of the impacted one of the energy absorbing members absorbs and transfers energy substantially uniformly from the impacted one of the energy absorbing members to the base wall.

9. An article as set forth in claim 1 wherein the energy absorbing members each include an outer wall transverse to the exterior surface of the base wall, with the outer wall of each of the energy absorbing members further defining the elliptical cross-sectional configuration.

10. An article as set forth in claim 9 wherein the outer wall of each of the energy absorbing members taper inwardly from the exterior surface of the base wall to the distal end of respective energy absorbing members.

11. An article as set forth in claim 1 wherein the distal end of each of the energy absorbing members define a recess extending along the central axis of respective energy absorbing members toward the exterior surface of the base wall to present an inner wall opposing the outer wall of respective energy absorbing members and a bottom wall transverse to the central axis of respective energy absorbing members.

12. An article as set forth in claim 11 wherein the inner wall of each of the energy absorbing members taper outwardly from the bottom wall to the distal end of respective energy absorbing members.

13. An article as set forth in claim 11 wherein the elliptical cross-sectional configuration is further defined as a substantially circular cross-sectional configuration perpendicular to the central axis of respective energy absorbing members, with the recess of each of the energy absorbing members further defining the substantially circular cross-sectional configuration.

14. An article as set forth in claim 1 wherein the energy absorbing members and the body are formed of a composite material molded together as one-piece.

15. An impact resistant article for a vehicle, the article comprising:
a body adapted to be attached to the vehicle and including a side wall and a base wall extending from the side wall, with the base wall including an exterior surface facing away from the vehicle; and
an energy absorbing member extending along a central axis from the exterior surface of the base wall to a distal end to absorb energy during an impact to the energy absorbing member, with the energy absorbing member including an outer wall transverse to the exterior surface, and with the distal end defining a recess extending along the central axis toward the exterior surface of the base wall to present an inner wall opposing the outer wall and a bottom wall transverse to the central axis;
wherein at least one of the outer and inner walls of the energy absorbing member defines a substantially circular cross-sectional configuration perpendicular to the central axis such that the energy absorbing member absorbs and transfers energy substantially uniformly from the energy absorbing member to the base wall when impacted.

16. An article as set forth in claim 15 wherein the outer and inner walls of the energy absorbing member each further define the substantially circular cross-sectional configuration, with the recess allowing the outer and inner walls of the energy absorbing member to deflect when being impacted.

17. An article as set forth in claim 15 wherein the outer wall of the energy absorbing member tapers inwardly toward the inner wall from the exterior surface of the base wall to the distal end and wherein the inner wall of the energy absorbing member tapers outwardly toward the outer wall from the bottom wall to the distal end.

18. An article as set forth in claim 15 wherein the outer wall of the energy absorbing member further defines the substantially circular cross-sectional configuration such that the outer wall absorbs and transfers energy substantially uniformly from the energy absorbing member to the base wall when impacted.

19. An article as set forth in claim 15 wherein the impact resistant article is further defined as an oil pan for the vehicle.

20. An article as set forth in claim 15 wherein the energy absorbing member and the body are formed of a composite material molded together as one-piece.
